(19) United States
(12) Patent Application Publication
(10) Pub. No.: US 2026/0299519 A1
(43) Pub. Date: Oct. 1, 2026

(54) WATCH WITH AN ANALOGUE DISPLAY FEATURING COAXIAL LUMINOUS HANDS

(71) Applicant: The Swatch Group Research and Development Ltd, Marin-Epagnier (CH)

(72) Inventor: Pierpasquale TORTORA, Neuchâtel (CH)

(73) Assignee: The Swatch Group Research and Development Ltd, Marin-Epagnier (CH)

(21) Appl. No.: 19/563,671

(22) Filed: Mar. 11, 2026

(30) Foreign Application Priority Data
Mar. 25, 2025 (EP) 25165934.8

(51) Int. Cl. G04B 19/32; G04B 19/04

(52) U.S. Cl. CPC G04B 19/32; G04B 19/042

(57) ABSTRACT

A watch (2) including an analogue display (6), at least one electroluminescent source (8a, 8c), and a light guide (30) located above said at least one electroluminescent source (8). The analogue display includes a first luminous hand (10) and a second luminous hand (12) pivotally arranged around the same axis of rotation (14); the elongate bodies (16, 17) of the first and second luminous hands extend respectively in a first general median plane (20) and a second general median plane (22) located above the first general median plane; the first luminous hand is fastened to a pipe (26) aligned with the axis of rotation and can be rotated by the movement. The light guide is carried by the first hand (10) and is rotationally attached thereto.

### CROSS REFERENCE TO RELATED APPLICATION

This application claims priority to European Patent Application No. 25165934.8 filed Mar. 25, 2025, the entire contents of which are incorporated herein by reference.

### TECHNICAL FIELD OF THE INVENTION

The present invention relates to watches with analogue displays featuring coaxial luminous hands. In particular, the luminous hands can radiate light when they are powered by electroluminescent sources such as LEDs (Light Emitting Diodes).

### Technological background

Document EP 1319998 describes a watch with an analogue display consisting of two coaxial luminous hands, namely an hour hand on a first level above the dial and a minute hand on a second level above the first. These two luminous hands are powered by LEDs arranged below the level of the rear surface of the dial, at the periphery of the pipes of these two luminous hands. The dial has an opening for the pipes of the two coaxial luminous hands, which is relatively large to allow the light produced by the LEDs to propagate axially/vertically towards annular parts (also referred to as “heads”) on these two hands surrounding the axis of rotation and having substantially the same diameter. An annular light guide is provided in the dial opening, the height of the light guide corresponding to the thickness of the dial. This light guide acts to guide the light produced by the LEDs as it passes through the dial opening.

The respective annular parts of the two luminous hands receive the light from the LEDs and inject this light into the transparent elongate bodies of these two luminous hands. Such a design has drawbacks, in particular because the light has to pass through the annular part of the hour hand to reach the annular part of the minute hand. This presents a problem, as the lower annular part acts to capture part of the light for the hour hand and also to transmit another part of this light to the annular part of the minute hand. To this end, a plurality of small reflectors is machined into the lower annular part in order, on one hand, to couple part of the light into the transparent elongate body of the hour hand and, on the other hand, to allow part of the light to pass into the zones outside the reflectors. This is a delicate and complex process.

Moreover, light is lost as it passes through the lower annular part and between the two annular parts, which necessarily have an interval between them. The light also dissipates to some extent in the lower annular part. It should be noted that the set of small reflectors, which are also provided in the upper annular part to couple the light with the elongate body of the minute hand, only fills part of the overlapping annular surfaces when viewed axially.

Document US 2024421275 describes a watch with an analogue display, also consisting of two coaxial luminous hands powered by LEDs arranged below the dial. Each of the two luminous hands is formed by an elongate body that ends in an annular head centred on the axis of rotation of these two hands. Each luminous hand is then formed by an opaque upper structure and a transparent lower structure arranged beneath the opaque upper structure. The opaque upper structure is planar and forms the elongate body and annular head of the luminous hand. The transparent lower structure also forms the elongate body and annular head of the luminous hand and has a tubular part that forms a light guide incorporated into the annular head of this hand and extends axially towards the dial. Firstly, it should be noted that the light guide for the lower luminous hand does not penetrate the dial opening and is therefore relatively far from the LEDs (see FIGS. 4A-4B).

In addition, the two light guides for the two luminous hands have the same outer diameter. Moreover, each light guide is completely covered by the opaque upper structure of the respective luminous hand. More specifically, the opaque upper structure of each luminous hand has, at the head of this luminous hand, an outer diameter that is greater than the diameter of the cylindrical outer surface of the light guide. Under these conditions, without further measures, the light generated by the LEDs can only reach the lower transparent structure of the lower luminous hand (located on the dial side). To allow the transparent lower structure of the upper luminous hand, located on the watch glass side, to receive light, secondary holes are machined into the head of the lower luminous hand, around the periphery of the main central opening in this head, so that part of the light from the LEDs passes through these secondary holes and then reaches the light guide for the upper luminous hand.

The watch disclosed in US 2024421275 has several drawbacks. In particular, machining secondary holes in the head of the lower luminous hand makes it more complex and more costly to manufacture. Secondly, it is difficult to ensure that a significant amount of light can reach the transparent lower structure of the upper luminous hand without weakening the head of the lower luminous hand. Furthermore, the secondary holes in the head of the lower luminous hand disrupt the coupling of the LED light into the lower transparent structure of the lower luminous hand.

### SUMMARY OF THE INVENTION

The invention aims to provide a watch comprising at least two coaxial luminous hands and at least one electroluminescent light source, in particular light-emitting diodes (LEDs), that provides a solution to the aforementioned problems of the watches described above. In particular, the intention is to provide such a watch that makes it possible to deliver more light from said at least one light source, located below the elongate bodies of the two coaxial luminous hands, to the second luminous hand that is located above the first luminous hand.

The invention relates to a watch comprising a movement, an analogue display, at least one electroluminescent source and a light guide located above said at least one electroluminescent source. The analogue display comprises a first luminous hand and a second luminous hand, which are pivotally arranged around the same axis of rotation and formed respectively by a first elongate body and by a second elongate body that each comprise a transparent lower structure in which light from said at least one electroluminescent source can propagate after propagating in the light guide, the first elongate body comprising a circular central part surrounding a pipe aligned on the axis of rotation and fastened to this pipe. The first elongate body extends in a first general median plane and the second elongate body extends in a second general median plane located above the first general median plane relative to the movement. According to the invention, the light guide is carried by a pivoting assembly formed by the first hand and by the pipe, and rotationally attached to this assembly. The light guide has a lower annular part that surrounds said pipe and that is located between said at least one electroluminescent source and the first general median plane, and an upper part that axially extends the lower annular part, outside the first hand when viewed axially in the first general median plane, at least as far as the first general median plane.

Due to the characteristics of the invention, the light guide can be elevated at least to the general median plane of the lower luminous hand, in particular the hour hand, at the periphery of the head of this hand and approach the light injection zone in the lower transparent structure of the upper luminous hand, in particular the minute hand. This ensures that a significant amount of light is guided to the lower transparent structure of the upper luminous hand and limits the amount of light lost between the upper surface of the light guide and the light injection zone in the upper luminous hand.

In an advantageous embodiment, said upper part of the light guide extends axially beyond the first general median plane towards the second general median plane, at least as far as an outer outline of the upper surface of the circular central part of the first elongate body, while remaining below the elongate body of the second luminous hand irrespective of its angular position relative to the first luminous hand.

As a result of the invention, the light guide can approach within a short distance of the lower transparent structure of the upper luminous hand to guide the light close to this upper luminous hand and optimise the amount of light transmitted to this upper luminous hand.

### BRIEF DESCRIPTION OF THE FIGURES

The invention will be described in greater detail below with reference to the appended drawings, which are given by way of non-limiting examples, in which:

FIG. 1 is a partial axial cross-sectional view of an advantageous embodiment of a watch according to the invention;

FIG. 2 is a partial enlargement of FIG. 1;

FIG. 3 is a perspective view of the hour hand, the light guide carried by this hour hand, and the electroluminescent sources forming the watch in FIG. 1;

FIGS. 4A and 4B are respectively a top perspective view and a plan view from the underside of the light guide in the previous figures;

FIG. 5 is a side view of an alternative embodiment of the light guide;

FIGS. 6A and 6B are top views of the light guide respectively seen in two particular angular positions relative to the electroluminescent sources; and

FIGS. 7A and 7B are perspective views from the underside of the hour hand and of the minute hand, respectively, of the watch in FIG. 1.

### DETAILED DESCRIPTION OF THE INVENTION

With reference to the appended figures, an advantageous embodiment of a watch according to the invention will be described below.

The watch 2 comprises a movement 4 incorporated in a case 3, an analogue display 6, electroluminescent sources 8a to 8d, and a light guide 30 located above said at least one electroluminescent source 8a to 8d, which are arranged on a printed circuit board/card 70 (also referred to as a “PCB”) arranged below the dial 50. In the variant shown, the PCB 70 is glued under the dial. The analogue display 6 comprises a first luminous hand 10 and a second luminous hand 12, which are pivotally arranged around the same axis of rotation 14 and are formed respectively by a first elongate body 16 and by a second elongate body 17 each comprising a transparent lower structure 18, 19 in which light provided by the electroluminescent sources can propagate. In the example shown, the analogue display 6 comprises a seconds hand fitted on an axis 27, the second luminous hand 12 forming the minute hand and fastened to an inner pipe 28, and the first luminous hand 10 forming the hour hand and fastened to the pipe 26, which is aligned with the axis of rotation 14 (the pipe 26 is an outer pipe having at its base a pinion that meshes with a wheel in the movement 4). The first elongate body 16 comprises a circular central part 11 that surrounds and is fastened to the pipe 26 (the term “central” relates to the axis of rotation 14). The first elongate body 16 of the first luminous hand 10 extends in a first general median plane 20 and the second elongate body 17 of the second luminous hand 12 extends in a second general median plane 22 located above the first general median plane relative to the movement 4.

The light guide 30 is carried by a pivoting assembly formed by the first luminous hand 10 and by the pipe 26, and rotationally attached to this assembly. In the advantageous embodiment described, the light guide 30 is carried by the first luminous hand 10. The light guide 30 comprises a lower annular part 32 that surrounds the pipe 26 and is located between the electroluminescent sources 8a to 8d and the first general median plane 20, and an upper part 34 that axially extends the lower annular part 32, outside the first elongate body 16 of the first luminous hand 10 when viewed axially in the first general median plane 20, at least as far as the first general median plane (alternative embodiment). In other words, the upper part 34 of the light guide 30 is at least partially located, when viewed axially in the first general median plane 20, outside the outer outline of the first luminous hand 10, more specifically at the periphery of the head of this first luminous hand, which is formed by the central circular part 11 in the alternative embodiment shown. It should be noted that the light guide 30 is a separate part from the first luminous hand 10.

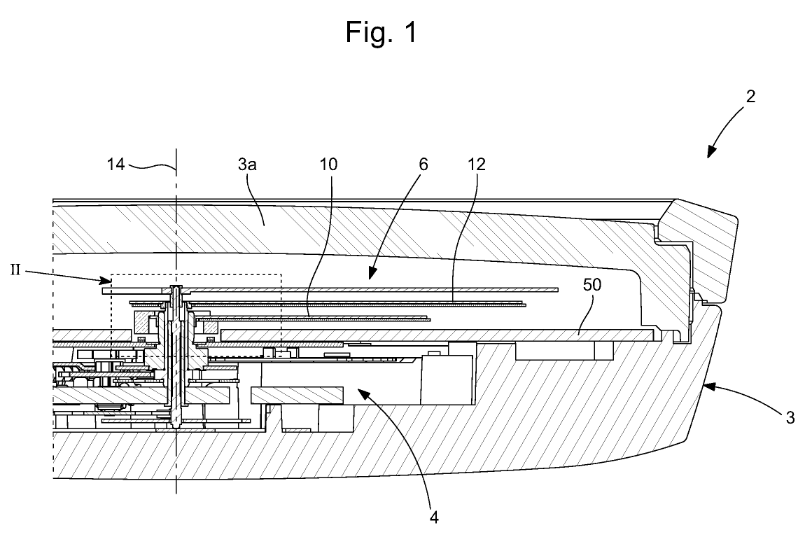

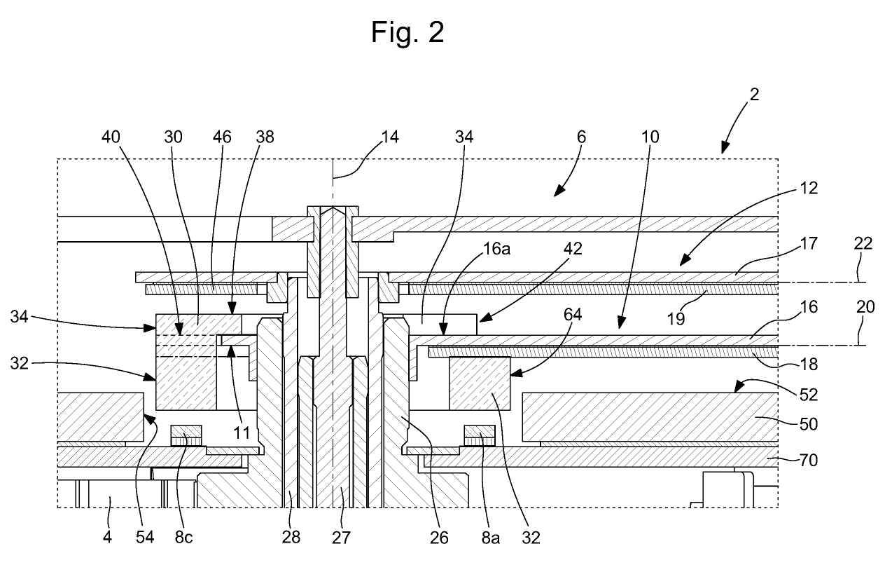

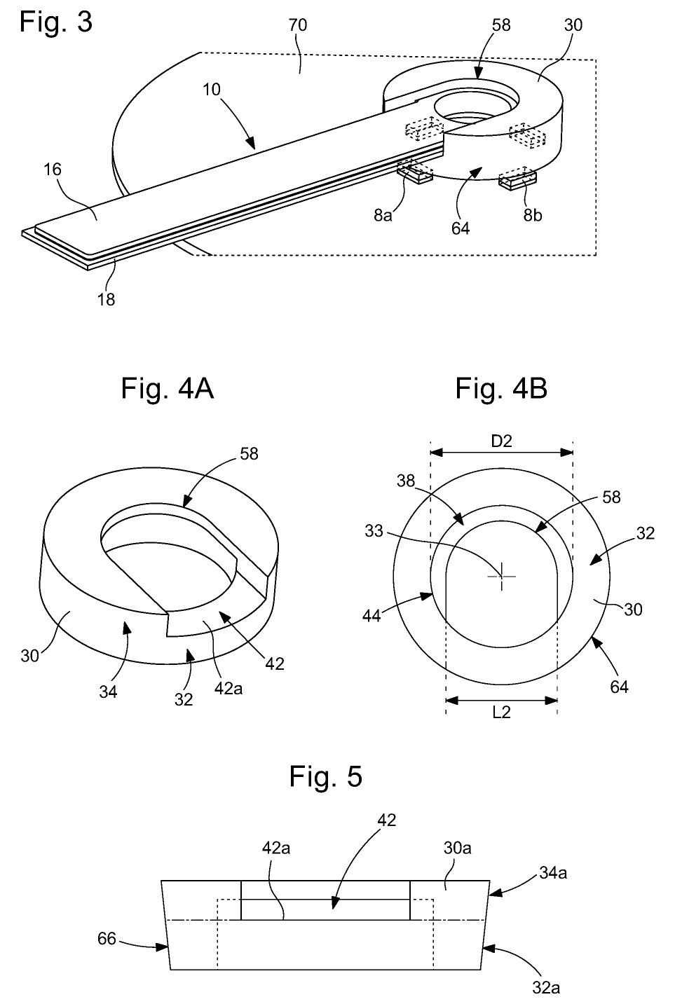

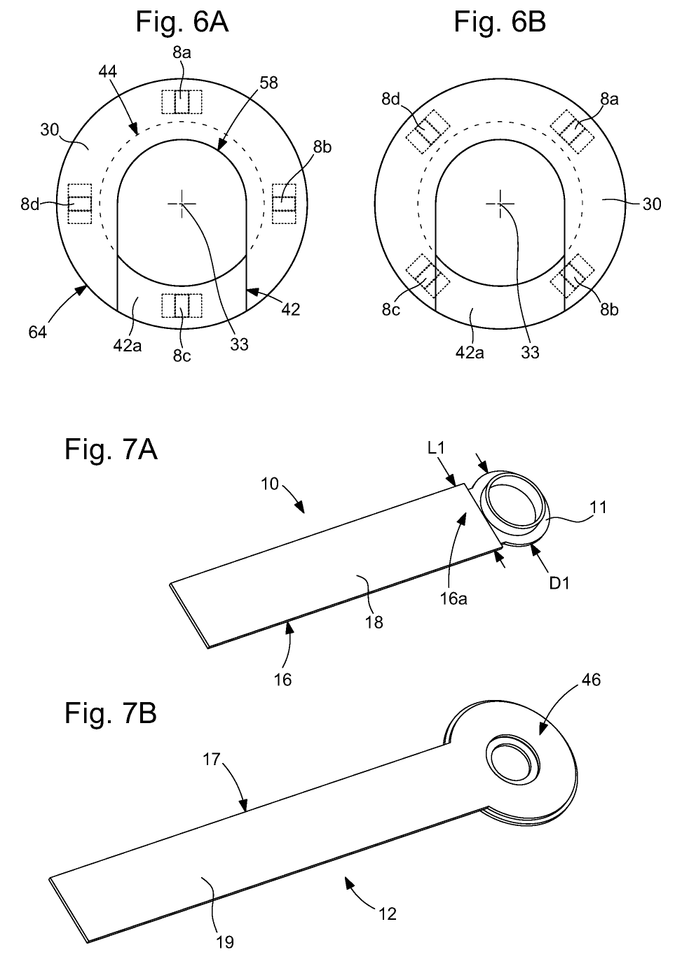

In an advantageous alternative embodiment, the upper part 34 of the light guide 30 extends axially beyond the first general median plane 20, towards the second general median plane 22, at least as far as the outer outline of the upper surface of the circular central part 11 of the first elongate body 16, while remaining below the elongate body 17 of the second luminous hand 12 irrespective of the angular position of this second luminous hand relative to the first luminous hand 10. In the preferred alternative embodiment shown in FIGS. 1 to 3, the upper part 34 of the light guide 30 extends axially beyond the first general median plane 20 and above the outer outline of the upper surface of the circular central part 11 while remaining below the elongate body 17 of the second luminous hand 12 irrespective of the angular position of this second luminous hand relative to the first luminous hand 10.

In an advantageous alternative embodiment, the upper part 34 of the light guide 30 has an inner part 38 that partially covers the circular central part 11 of the first luminous hand 10 and thus enables the rotating assembly, formed by the luminous hand 10 and by the pipe 26, to carry the light guide 30 axially (in particular when the watch is in a horizontal position with the watch glass 3a at the top). In an alternative embodiment, the inner part 38 of the light guide is glued to the circular central part 11 of the luminous hand 10 (or alternatively, in one alternative embodiment, to an upper part of the pipe 26, which has been modified for this purpose).

In an advantageous alternative embodiment, the upper part 34 of the light guide 30 has, in the circular central part 11 of the first hand 10, a positioning part 40 that is configured to surround the circular central part 11 over an angular distance θ greater than 180° and to present a lateral opening 42, for the elongate body 16 of the first luminous hand, which has a width L2 that is smaller than the outer diameter D1 of the circular central part 11. Thus, at least in the circular central part, the light guide has an outer diameter that is greater than the outer diameter D1 of the circular central part 11 and more generally than the dimensions of the head of the first luminous hand 10, more specifically of its elongate body 16, this head comprising the circular central part 11. In the alternative embodiment in FIGS. 1 to 4B, the lower annular part 32 of the light guide 30 has a cylindrical outer surface 64, which has an outer diameter greater than the outer diameter D1 of the circular central part 11, and the upper part 34 has an outer surface that partially extends said cylindrical outer surface. In this main alternative embodiment, the light guide 30 has an outer diameter that is therefore greater than the outer diameter of the head of the first luminous hand 10, in particular of the circular central part 11 forming this head.

In a particular alternative embodiment, the width L2 of the lateral opening 42 of the positioning part 40 corresponds substantially to the width L1 of the elongate body 16 (which is defined by the width of the transparent lower structure 18 in the example shown) of the first luminous hand 10 in its initial portion 16a located in this lateral opening, so that the light guide 30 is angularly positioned by the elongate body of the first luminous hand 10. The lateral opening 42 has a lower surface 42a against which the initial portion 16a of the elongate body 16 of the first luminous hand 10 can bear. If the light guide is not glued to the circular central part 11 of the luminous hand 10 (or alternatively to an upper part, modified for this purpose, of the pipe of this luminous hand), the inner part 38 and the lower surface 42a of the lateral opening 42 rotationally lock the light guide 30 around a horizontal axis orthogonal to the axis of rotation 14 and to a central axis of the lateral opening, in the direction in which the lower part 32 of the light guide comes into contact with the elongate body 16 of the luminous hand 10, but not in the other direction. Since the light guide has a certain amount of unbalance on the side diametrically opposite the lateral opening 42, when the watch is in a horizontal position with the glass 3a at the top, the light guide 30 remains in place on the first luminous hand 10 without being fastened to this first luminous hand. Preferably, the positioning part 40 has a circular inner surface 44 with a diameter D2 that is aligned, within manufacturing and assembly tolerances, with the outer diameter D1 of the circular central part 11 of the luminous hand 10.

According to an advantageous alternative embodiment, the transparent lower structure 19 of the second luminous hand 12 comprises a central part 46, which is circular and axially overlaps at least the greater part of the upper part 34 of the light guide 30, more specifically at least the greater part of the upper surface of the light guide. The central part 46 forms the head of the second luminous hand 12, more specifically the head of its elongate body 17. In the main alternative embodiment in which the light guide has a cylindrical outer surface centred on the axis of rotation 14, the circular central part 46 of the transparent lower structure 19 of the second luminous hand 12 has an outer diameter that is greater than the diameter of the head of the first luminous hand, in particular of the circular central part 11. Preferably, the diameter of the circular central part 46 is substantially equal to or greater than the diameter of the light guide 30. Preferably, the circular central part 46 is covered by an opaque circular part of the elongate body 17 of the second luminous hand. In particular, this opaque circular part advantageously has dimensions equal to or greater than the dimensions of the upper surface (the surface from which the light exits the light guide) of the upper part of the light guide.

In an advantageous embodiment of the first and second luminous hands 10 and 12, the elongate body 16, 17 of each of these hands comprises an opaque upper part that at least covers part of, preferably most of, the corresponding transparent lower part 18, 19. In particular, the opaque upper part of the first luminous hand 10 comprises the circular central part 11, and the opaque circular part of the second hand 12 extends above the circular central part 46 of the transparent lower structure 19 and of the upper surface of the light guide 30.

In a preferred alternative embodiment, the electroluminescent sources 8a to 8d are arranged below the upper surface 52 of the dial, which has an opening 54 for the pipes 26 and 28 and for the propagation of the light produced by the electroluminescent sources for injection into the light guide 30. In an advantageous alternative embodiment, the lower annular part 32 of the light guide 30 penetrates into the opening 54 in the dial 50, this opening being circular with a diameter greater than the outer diameter of said lower annular part.

The upper part 34 of the light guide 30 has an axial opening 58 through which the pipe 28 (alternatively the axis) to which the second luminous hand 12 is fastened can run. According to advantageous characteristics for fitting the light guide 30 to the first luminous hand 10 (more generally to the assembly formed by this luminous hand 10 and by the pipe 26), said axial opening 58 is dimensioned to allow, when the light guide 30 is fitted to said assembly, the elongate body 16 of the first luminous hand 10 to pass through, in a direction substantially parallel to the central axis 33 of the lower annular part 32 of the light guide 30, before levering the elongate body 16 of the first luminous hand until it reaches a position in which it extends radially relative to said central axis 33, and the inner part 38 of the upper part 34 of the light guide 30 bears axially on the circular central part 11 of the first luminous hand while the initial portion 16a of the elongate body of the first hand is facing, preferably bearing on, an upper surface of the lower annular part 32, which in the alternative embodiment shown corresponds to the lower surface 42a of the lateral opening 42.

In an advantageous alternative embodiment, shown in FIG. 5, the lower annular part 32a of the light guide 30a has an inverted frustoconical outer surface 66. By way of example, the angle of inclination of the inverted frustoconical outer surface 66 is equal to 5°. Preferably, the upper part 34a of the light guide 30a partially extends the frustoconical outer surface. This frustoconical shape of the light guide makes it possible to reduce the diameter of the opening 54 in the dial 50 and to make the light guide 30a less visible to a user of the watch.

Lastly, it should be noted that the outer surface 64 of light guide 30, or the outer surface 66 of light guide 30a, can be treated in various ways. In particular, a metallic deposit can be applied to the outer surface of the light guide to keep any light from shining through the outer surface. A person skilled in the art can obviously use various methods to treat the light injection zone provided in each of the lower transparent structures 18, 19 of the luminous hands 10 and 12 (zones in which the light exiting from the light guide is introduced into the lower transparent structures forming the elongate bodies of these two hands). The same observation applies to the lower surface of the light guide 30, through which the light from the LEDs in the light guide is injected, and to the upper surface of this light guide, through which light must be able to exit for the second luminous hand 12.

1. A watch comprising a movement, an analogue display, at least one electroluminescent source and a light guide located above said at least one electroluminescent source; the analogue display comprising a first luminous hand and a second luminous hand, which are pivotally arranged around the same axis of rotation and formed respectively by a first elongate body and by a second elongate body that each comprise a transparent lower structure in which light from said at least one electroluminescent source can propagate after propagating in the light guide, the first elongate body comprising a circular central part surrounding a pipe aligned on the axis of rotation and fastened to this pipe, the first elongate body extending in a first general median plane and the second elongate body extending in a second general median plane located above the first general median plane relative to the movement; wherein the light guide is carried by a pivoting assembly formed by the first hand and by the pipe and rotationally attached to this assembly, the light guide having a lower annular part that surrounds said pipe and is located between said at least one electroluminescent source and the first general median plane, and an upper part that axially extends the lower annular part, outside the first luminous hand when viewed axially in the first general median plane, at least to the first general median plane.

2. The watch according to claim 1, wherein said upper part of the light guide extends axially beyond the first general median plane towards the second general median plane, at least as far as an outer outline of the upper surface of the circular central part of the first elongate body, while remaining below the elongate body of the second luminous hand irrespective of its angular position relative to the first luminous hand.

3. The watch according to claim 2, wherein said upper part of the light guide extends axially above said outer outline of the upper surface of the circular central part of the first elongate body.

4. The watch according to claim 3, wherein said upper part of the light guide has an inner part that partially covers the circular central part of the first luminous hand, thus enabling said assembly to axially carry the light guide.

5. The watch according to claim 4, wherein said upper part of the light guide has, in the circular central part of the first luminous hand, a positioning part that is configured to surround the circular central part over an angular distance greater than 180° and to present a lateral opening, for the elongate body of the first luminous hand, which has a width that is smaller than the outer diameter of the circular central part.

6. The watch according to claim 5, wherein the width of said lateral opening of the positioning part corresponds substantially to the width of the elongate body of the first luminous hand in its initial portion located in this lateral opening, so that the light guide is angularly positioned by the elongate body of the first luminous hand.

7. The watch according to claim 5, wherein said positioning part has a circular inner wall with a diameter that is aligned, within manufacturing and assembly tolerances, with the outer diameter of said circular central part.

8. The watch according to claim 5, wherein said upper part of the light guide has an axial opening through which runs an axis or pipe to which the second luminous hand is fastened, this axial opening being dimensioned to allow, when the light guide is fitted to said assembly, the elongate body of the first luminous hand to move in a direction substantially parallel to a central axis of said lower annular part, before levering this elongate body until it reaches a position in which it extends radially relative to said central axis and said inner part of the upper part of the light guide bears axially on said circular central part of the first hand while an initial portion of the elongate body of the first hand is located in said lateral opening of the upper part of the light guide.

9. The watch according to claim 1, wherein the transparent lower structure of the second luminous hand comprises a central part that axially overlaps at least the greater part of the upper surface of the light guide.

10. The watch according to claim 1, in which the watch comprises a dial arranged on the movement below the first and second luminous hands; wherein said at least one electroluminescent source is arranged below the upper surface of the dial, which has an opening through which the pipe and the light produced by said at least one electroluminescent source for injection into the light guide can pass.

11. The watch according to claim 10, wherein the lower annular part of the light guide penetrates into said opening in the dial, said opening being circular with a diameter greater than the outer diameter of the lower annular part.

12. The watch according to claim 1, wherein the lower annular part of the light guide has a cylindrical outer surface centred on the axis of rotation.

13. The watch according to claim 1, wherein the lower annular part of the light guide has an inverted frustoconical outer surface.
